(19) United States
(12) Patent Application Publication
(10) Pub. No.: US 2010/0034858 A1
(43) Pub. Date: Feb. 11, 2010

(54) BIOCIDAL COATINGS

(75) Inventors: Simon Champ, Ludwigshafen (DE); Oliver Koch, Eppelheim (DE); Monica Ek, Haegersten (SE); Eva-Helena Westman, Stockholm (SE); Lars Wagberg, Lidingoe (SE); Robert Feuerhake, Mannheim (DE); Hans-Joachim Haehnle, Neustadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/513,859

(22) PCT Filed: Nov. 5, 2007
(86) PCT No.: PCT/EP2007/061853

§ 371 Date: May 7, 2009

(30) Foreign Application Priority Data
Nov. 10, 2006 (EP) 06023439.0

(51) Int. Cl. A01N 25/10

(52) U.S. Cl. 424/409

(57) ABSTRACT

Biocidal multilayered system, characterized in that it comprises at least the following layers: —an anionic or cationic carrier, preferably cellulose as anionic carrier, —on this carrier alternating polymeric cationic and anionic layers starting with a layer having a charge opposite to that of the carrier, —wherein at least one layer is hydrophobically modified.

The invention relates to a biocidal multilayered system, characterized in that it comprises at least the following layers:
an anionic or cationic carrier, preferably cellulose as anionic carrier,
on this carrier alternating polymeric cationic and anionic layers starting with a layer having a charge opposite to that of the carrier,
wherein at least one layer is hydrophobically modified.

Biocidal agents kill off microorganisms, such as bacteria, fungi, yeasts, algae or viruses, or prevent at least their reproduction and/or growth.

In the most varied substrates there is a wish, often indeed a need, for a biocidal treatment. Examples of these include substrates for medical applications, packaging materials for foodstuffs or substrates for diverse industrial applications, in particular filters, e.g. for air conditioning systems.

The biocidal action of polyvinylamines, also in combination with quaternary ammonium salts, is disclosed, for example, in U.S. Pat. No. 6,261,581 and DE-A 196 08 555, and in this German patent application having the file reference number 10 2005 021 364.2, which on the priority date of this application has not yet been published.

The biocidal action of polyethylenimines, hydrophobically modified polyethylenimines and of mixtures of polyethylenimines with quaternary ammonium salts is disclosed, for example, in WO 2004/087226 or the following publications.

“Immobilized N-alkylated polyethylenimine avidly kills bacteria by rupturing cell membranes with no resistance developed”, Nebojsa M. Milovic, Jun Wang, Kim Lewis, Alexander M. Klibanov, Biotechnology and Bioengineering, Vol. 90, No. 6, Jun. 20, 2005, pages 715-722 and “Surpassing nature: rational design of sterile-surface materials”, Kim Lewis and Alexander M. Klibanov, Trends in Biotechnology, Vol. 23, No. 7, July 2005, pages 343-348.

Multilayered systems of alternating anionic and cationic polyelectrolytes and their preparation are disclosed in WO 00/32702. Papers and nonwoven fabrics (nonwovens) are coated with this multilayered system in order in particular to increase the strength of the substrates.

The preparation of hydrophobically modified polyvinylamines and their use in paper production are described, for example, in WO 97/42229 and WO 03/099880.

The biocidal action of coatings produced to date with polyvinylamines or polyethylenimines is often not quite adequate.

Accordingly, it was an object of the present invention to provide coatings of these polymers having improved biocidal action.

Correspondingly, the multilayered system defined at the outset and its use were discovered. The use of hydrophobically modified polyvinylamine as a biocidal agent, in particular in association with the multilayered system, was also found.

### The Carrier

The carrier can be composed of any material; examples which come into consideration are carriers composed of synthetic or natural polymers containing anionic or cationic groups.

A preferred carrier is cellulose. Cellulose usually has anionic groups and, accordingly, is an anionic carrier.

The carrier can be pretreated in order to produce ionic groups on its surface or to increase the number of ionic groups on the surface of the carrier. For example, the surface of cellulose can be treated with an oxidizing agent to increase the number of anionic groups.

### The Layers in General

The layers are formed from polymers. The cationic polymer layers consist of polymers having cationic groups and the anionic polymer layers consist of polymers having anionic groups.

The cationic and anionic polymer layers in the multilayered system each contain preferably 0.1 to 22 milliequivalents of ionic groups (cationic or anionic groups), particularly preferably at least 0.5 and very particularly preferably at least 1 milliequivalent of ionic groups/1 gram of polymer.

The polymer layers contain preferably 0.001 to 1000 mg, particularly preferably 0.01 to 100 mg and very particularly preferably 0.1 to 10 mg of polymer/square meter.

The polymer layers of the multilayered system are alternately cationic and anionic. On top of an anionic carrier there necessarily follows a cationic polymer layer and on top of a cationic polymer layer there necessarily follows an anionic polymer layer and vice versa.

The multilayered system contains at least one cationic polymer layer and at least one anionic polymer layer. Accordingly, the multilayered system contains in total at least two polymer layers, preferably it contains more than two polymer layers, in particular at least three polymer layers, particularly preferably at least four polymer layers. The number of polymer layers can have any magnitude, but is generally not greater than 20, or than 10.

The total weight of all polymer layers together amounts preferably to 0.05 to 1000 mg, particularly preferably 0.1 to 100 mg and very particularly preferably 0.5 to 50 mg, in particular 1 to 20 mg of polymer/square meter of carrier (Note: One gram of cellulose of customary thickness corresponds to approx. 1 square meter).

The total thickness of all polymer layers can be, for example, 3 nm to 1 μm.

### The Cationic Polymers

The polymer in the cationic layer can be any polymer having cationic groups. For the cationic groups, cationic groups having quadricovalent nitrogen (ammonium groups) are preferred; in particular the quadricovalent nitrogen carries hydrogen atoms as substituents apart from the bonds to the polymer (one bond in the case of polyvinylamines or two bonds in the case of polyethylenimines).

For the cationic polymers, polyethylenimines or polyvinylamines in particular come into consideration.

Here a polyethylenimine is defined as any polymer which is built up of at least 10% by weight, preferably of at least 30% by weight, very particularly preferably of at least 50% by weight, and especially of at least 70% by weight of repeat units of formula I

—CH₂—CH₂—N— (I)

where the N atom may have another substituent, in particular a H atom, or two other substituents; in the latter case this is a quaternary ammonium group with a positive charge on the N atom (cationic group).

Here also a polyvinylamine is defined as any polymer which is built up of at least 10% by weight, preferably of at least 30% by weight, very particularly preferably of at least 50% by weight, and especially of at least 70% by weight of repeat units of formula II

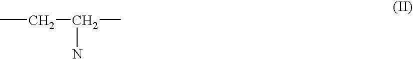

where the N atom may have two other substituents, in particular two H atoms (primary amino group), or three other substituents; in the latter case this is a quaternary ammonium group with a positive charge on the N atom (cationic group).

In a special embodiment the polyethylenimine consists of at least 90% by weight, in particular of 100% by weight, of units of formula I.

In a special embodiment the polyvinylamine of formula II consists of at least 90% by weight, in particular of 100% by weight of units of formula II.

Polyvinylamines are particularly preferred as polymers for the cationic layer.

### The Polyvinylamines

In particular polyvinylamines are polymers of vinylcarboxylamides which in particular contain secondary and tertiary amino groups in the form of substituted amide groups and particularly preferred are polymers containing primary amino groups obtainable from these polyvinylcarboxylamides by hydrolysis.

In particular the polyvinylamines are produced by polymerizing monomers containing N-vinylcarboxylamide units and subsequent hydrolysis. The are obtainable, for example, by polymerizing N-vinylformamide, N-vinyl-N-methylformamide, N-vinylacetamide, N-vinyl-N-methylacetamide, N-vinyl-N-ethylacetamide and N-vinylpropionamide. The named monomers can be polymerized either on their own or together with other monomers. N-vinylformamide is preferred.

Monoethylenically unsaturated monomers that come into consideration for copolymerization with N-vinylcarboxylamides include all those compounds which are copolymerizable therewith. Examples of these are vinyl esters of saturated carboxylic acids having 1 to 6 carbon atoms such as vinyl formate, vinyl acetate, N-vinylpyrrolidone, N-vinylimidazole, N-vinylimidazoline, vinyl propionate and vinyl butyrate and vinyl ethers such as C1 to C6 alkyl vinyl ethers, e.g. methyl or ethyl vinyl ether, Other suitable comonomers are esters of alcohols having, for example, 1 to 12 carbon atoms or amides and nitriles of ethylenically unsaturated C3 to C6 carboxylic acids, for example methyl acrylate, methyl methacrylate, ethyl acrylate, ethyl methacrylate and dimethyl maleate, acrylamide and methacrylamide as well as acrylonitrile and methacrylonitrile.

Polymerization of the monomers is usually carried out in the presence of polymerization initiators which form free radicals. Homo- and copolymers can be obtained by all known methods, for example they are obtained by solution polymerization in water, alcohols, ethers or dimethylformamide or in mixtures of different solvents, by precipitation polymerization, reverse suspension polymerization (polymerization of an emulsion of an aqueous phase containing monomer in an oil phase) and polymerization of a water-in-water emulsion, in which, for example, an aqueous monomer solution is dissolved or emulsified in an aqueous phase and polymerized to form an aqueous dispersion of a water-soluble polymer, as described, for example, in WO 00/27893. Following polymerization, the homo- and copolymers containing embedded N-vinylcarboxylamide units are partially or completely hydrolyzed if primary amino groups are desired.

The degree of hydrolysis can be, for example, 1 to 100 mol. %, preferably 25 to 100 mol. %, particularly preferably 50 to 100 mol. % and especially preferably 70 to 100 mol. %. The degree of hydrolysis corresponds to the content of primary vinylamine groups in mol. % in the polymers.

As a rule only the hydrolyzed primary amino groups can be easily converted into a cationic group; accordingly, the degree of hydrolysis is at least 10 mol. %, in particular at least 20 mol. %.

Hydrolysis of the polymers described above is carried out according to known methods by the action of acids (e.g. mineral acids such as sulfuric acid, hydrochloric acid or phosphoric acid, carboxylic acids such as formic acid or acetic acid, or sulfonic acids or phosphonic acids), bases or enzymes, as described, for example, in DE-A 31 28 478 and U.S. Pat. No. 6,132,558. When acids are used as hydrolyzing agent the vinylamine units in the polymers are present in the form of the ammonium salt, while on hydrolysis with bases the free amino groups are obtained.

The average relative molar masses, MW, of the vinylamines can be, for example, 500 to 10 million, preferably 750 to 5 million and particularly preferably 1,000 to 2 million g/mol. (determined by light scattering). This range of relative molar masses corresponds, for example, to K values of 30 to 150, preferably 60 to 100 (determined according to H. Fikentscher in 5% aqueous common salt solution at 25° C., a pH of 7 and a polymer concentration of 0.5% by weight). Particularly preferably polyvinylamines are used which have a K value of 85 to 95.

The cationic groups can be readily introduced into the polyvinylamine by adjusting the pH. The milliequivalents of cationic groups specified above generally appear at a pH of less than 7, in particular less than 6.

The charge density at pH 7 is in particular from 5 to 18 meq/g and in particular from 10 to 16 meq/g.

The polyvinylamine is preferably employed in the form of an aqueous dispersion or solution.

### The Anionic Polymers

The polymer in the anionic layers is in particular a polyacid in which an appropriate proportion of the acid groups is present in the form of the anionic salt group.

The acid group can be, for example, a carboxylic acid, a sulfonic acid or a phosphonic acid group, preferably a carboxylic acid group.

This is in particular a polyacrylic acid or polymethacrylic acid (poly(meth)acrylic acid).

By poly(meth)acrylic acid is meant a polymer which is made up to the extent of at least 10% by weight, preferably of at least 30% by weight, very particularly preferably of at least 50% by weight and especially of at least 70% by weight of acrylic acid or methacrylic acid units or salts thereof.

The poly(meth)acrylic acid may contain the monomers identified above as comonomers.

In a particular embodiment the poly(meth)acrylic acid consists of at least 90% by weight and especially of 100% by weight of (meth)acrylic acid or salts thereof.

The above content levels of anionic groups can be readily achieved by adjusting the pH, preferably to a pH greater than 6 and in particular greater than 7.

The proportion of anionic groups in the anionic polymer, preferably the polyacid, is as specified above for ionic groups.

### The Hydrophobically Modified Layer

According to the invention at least one of the polymer layers is hydrophobically modified. For this purpose either the polymer in the cationic layer or the polymer in the anionic layer can be suitably modified by a proportion of hydrophobic groups.

Particularly preferably the outermost layer is hydrophobically modified and particularly preferably the outermost layer is a hydrophobically modified cationic layer.

Preferably at least one of the cationic polymer layers is hydrophobically modified, but a plurality, all or just one of the cationic layers may be hydrophobically modified. Particularly preferably only one cationic layer is hydrophobically modified and in this case the particular layer in question is the outermost layer.

In the case of hydrophobic modification also, the polymer in question further contains the above proportion of anionic or cationic groups.

By hydrophobic modification is meant the existence of hydrophobic side groups on the main chain of the polymer; the hydrophobic groups are terminal groups, i.e. they are located at the end of the side chain and do not link the polymer main chain to other polymer main chains.

The hydrophobic groups need not be directly connected to the polymer main chain, on the contrary the linkage may even be made via hydrophilic groups, e.g. the ammonium group of the polyvinylamine.

The hydrophobic groups are, in particular, hydrocarbon groups or halogenated hydro-carbon groups containing at least 2 interconnected C atoms and particularly preferably containing at least 3 interconnected C atoms.

These can be, for example, alkyl groups or aryl groups. Groups which come into consideration are alkyl groups having at least 2, preferably at least 3, particularly preferably at least 4 C atoms or halogen derivatives thereof. The number of C atoms is generally no more than 30, in particular no more than 20. The groups may also be alkoxy or polyalkoxy groups, these being alkoxy groups having at least 3 C atoms and in particular a propoxy or polypropoxy group. The hydrophilic group is usually not directly connected to the main polymer chain and is preferably linked to the main polymer chain via an intervening group (spacer) which may also be hydrophilic.

The proportion of hydrophobic groups in the hydrophobic anionic or cationic layer is preferably 0.01 to 2.5 mol per 100 gram of polymer, particularly preferably the proportion is at least 0.05, very particularly preferably at least 0.1 mol and in a particular embodiment at least 0.2 mol per 100 g of polymer. The proportion of hydrophobic groups is generally less than 2 mol, in particular less than 1.5 mol, per 100 gram of polymer. A common range is, in particular, 0.2 to 1.5 mol or 0.5 to 1.5 mol per 100 gram of polymer.

### Hydrophobically Modified Polyvinylamine

The hydrophobically modified polymer is preferably a hydrophobically modified polyvinylamine or polyethylenimine (cationic polymer or cationic layer). The hydrophobic modification of polyethylenimines is described, for example, in WO 2004/087226 and hydrophobically modified polyvinylamines are described, for example, in WO 97/42229 and WO 03/099880.

For purposes of the hydrophobic modification of polyvinylamines, preferably primary amino side groups (—NH2) are alkylated and treated to this end with suitable reactive compounds.

The reactive compounds which come into consideration are, for example, isocyanate compounds, compounds having a carboxylic acid group or, in particular, compounds containing an epoxy group.

Particularly preferred is a compound containing an epoxy group. After reaction of the primary amino group with the epoxy compound (e.g. epoxybutane) a H atom in the amino group has been replaced by the corresponding beta-hydroxy group (in this example the hydrophobic group is the terminal ethyl group).

In order to produce the hydrophobically modified polyvinylamine the procedure set out below can be used.

First of all hydrolysis of polyvinylcarboxylamides (see above) is carried out under alkaline or acidic conditions and stopped by changing the pH as soon as the desired degree of hydrolysis and hence the desired quantity of primary amino groups has been achieved. After this treatment with the reactive compound ensues in a second step.

It is advantageous to use a single-stage reaction in which a start is first made with the hydrolysis and then the reactive compound (epoxy compound) is added before hydrolysis has gone to completion. By suitable choice of quantities and the timing of addition the desired degree of hydrolysis and the desired extent of conversion by the reactive compound can simultaneously be determined.

In polyvinylamines and polyethylenimines the N atom to which the hydrophobic group is directly or indirectly attached may also at the same time be cationic. To achieve this the pH of the hydrophobic polyvinylamine or polyethylenimine is suitably adjusted.

### Preparation of the Multilayered System

The multilayered system can be produced as already described, for example, in WO 00/32702. In doing so the carrier is first of all treated with the oppositely charged polymer. If the carrier is anionic, like cellulose for example, the carrier is first treated with the solution of the cationic polymer. To do this the carrier can be simply immersed in the solution. Due to electrostatic attraction a layer of the cationic polymer is deposited and is bound to the carrier by electrostatic attraction. Any polymer not bound can be washed off, e.g. by immersion in water. The carrier coated in this way can then be correspondingly enveloped in other layers by always immersing it in the corresponding solution of polymer of opposite charge to the outermost layer.

Accordingly, the cationic and anionic layers of the multilayered system are bound to one another in particular by formation of a polyelectrolyte system of the anionic groups of the anionic polymer with the cationic groups of the cationic polymer.

### Use

The hydrophobic, cationic polyvinylamine has a biocidal action and can be employed as a biocide for the most varied purposes, e.g. in the foods sector for packaging materials treated with biocide, in the medical sector for preparations and devices treated with biocide and in the industrial sector as filters treated with biocide, for example, in particular filters in air conditioning units. To do this it can be applied in simple form to the substrates (carriers) to be given biocidal treatment.

The biocidal action of the hydrophobic polyvinylamine is reinforced by the multilayered system. Accordingly, the multilayered system is most particularly suitable for the above purposes, in particular for the foods sector (packaging materials treated with biocide) and the medical sector (preparations and devices treated with biocide). To do this it can be applied as described above to the substrates (carriers) to be given biocidal treatment.

Substrates composed of natural or synthetic polymers, paper or metal are suitable as carriers.

Carriers coated with biocide are outstandingly effective against microorganisms such as viruses, yeasts, fungi and in particular against bacteria.

### EXAMPLES

### Preparation of the Hydrophobic Polyvinylamines

The K values were determined in accordance with H. Fikentscher, Cellulose-Chemie (Cellulose Chemistry), Vol. 13, pp. 58-64 and 71-74 (1932) as a 0.1% solution in 5% sodium chloride solution.

Details shown in % are to be understood as % by weight.

The degree of hydrolysis was determined by the enzymic formic acid method.

Complete reaction of the alkylating compound was determined by the Preuβmann test (R. Preuβmann, Arzneimittel-Forschung 1969, 19, 1059-1073.).

### Example 1

### Preparation of Polyvinylamine from Poly(Vinyl Formamide)

773.8 g of a 13% by wt. solution of a poly(vinyl formamide) (K value: 88) were mixed with 7.4 g of a 40% by wt. solution of sodium bisulfite and heated to 80° C. This hot mixture was treated with 249.1 g of a 25% by wt. NaOH solution. After 5 h the mixture was allowed to cool to room temperature.

The degree of hydrolysis in the product was 92.5% (with respect to the VFA monomer).

### Example 2

125.6 g of a PVAm solution from Example 1 (polyvinylamine content: 9.8% by wt.) were weighed out into a flask to which were added 2.3 g of epoxybutane (20 mol. % with respect to the VFA monomer content). The reaction solution was then heated to 80° C. and stirred at this temperature for 4 h. After this, the solution was allowed to cool to room temperature and adjusted to pH 7.0 with concentrated HCl solution.

### Example 3

150.4 g of a PVAm solution from Example 1 (polyvinylamine content: 9.8% by wt.) were weighed out into a flask to which were added 5.9 g of epoxyhexane (30 mol. % with respect to the VFA monomer content). The reaction solution was then heated to 60° C. and stirred at this temperature for 5 h. After this the solution was allowed to cool to room temperature and adjusted to pH 7.0 with concentrated HCl solution and then diluted by adding 54 g of deionized water.

### Example 4

68.8 g of a 20% by wt. solution of a poly(vinyl formamide) (K value: 87) were diluted with 73.0 g of deionized water, mixed with 1.0 g of a 40% by wt. sodium bisulfite solution and heated to 80° C. To this heated solution were added 13.2 g of a 25% by wt. solution of NaOH. After 90 minutes it was cooled to 60° C. and 2.92 g of epoxyhexane (15 mol. % with respect to the VFA monomer content) were added. After this the reaction solution was heated up again to 80° C., stirred at this temperature for a further 90 minutes and then allowed to cool to room temperature and adjusted to pH 8.0 with concentrated HCl solution.

### Example 5

150.0 g of a 13% by wt. solution of a poly(vinyl formamide) (K value: 90) were diluted with 50.0 g of deionized water, mixed with 1.4 g of a 40% by wt. sodium bisulfite solution and heated to 80° C. To this heated solution were added 13.2 g of a 25% by wt. solution of NaOH. After 105 minutes it was cooled to 60° C. and 1.09 g of epoxyoctane (3 mol. % with respect to the VFA monomer content) was added. After this the reaction solution was heated up again to 80° C., stirred at this temperature for a further 60 minutes and then adjusted to pH 8.0 with concentrated HCl solution. To complete the reaction the solution was stirred for a further 120 minutes at 80° C.

The degree of hydrolysis in the product was 29.8% (with respect to the VFA monomer).

### Example 6

85.2 g of a 22% by wt. solution of a poly(vinyl formamide) (K value: 91) were diluted with 107.9 g of deionized water, mixed with 1.3 g of a 40% by wt. sodium bisulfite solution and heated to 80° C. To this heated solution were added 12.6 g of a 25% by wt. solution of NaOH. After 90 minutes it was cooled to 60° C. and 0.15 g of epoxydecane (0.3 mol. % with respect to the VFA monomer content) was added. After this the reaction solution was heated up again to 80° C., stirred at this temperature for a further 90 minutes and then adjusted to pH 8.0 with concentrated HCl solution.

The degree of hydrolysis in the product was 30.4% (with respect to the VFA monomer).

### Example 7

83.3 g of a 20% by wt. solution of a poly(vinyl formamide) (K value: 87) were diluted with 84.8 g of deionized water, mixed with 1.2 g of a 40% by wt. sodium bisulfite solution and heated to 80° C. To this heated solution were added 15.3 g of a 25% by wt. solution of NaOH. After 105 minutes it was cooled to 60° C. and 0.86 g of epoxbutane (5 mol. % with respect to the VFA monomer content) was added. After this the reaction solution was heated up again to 80° C., stirred at this temperature for a further 135 minutes and then adjusted to pH 8.0 with concentrated HCl solution.

The degree of hydrolysis in the product was 50.1% (with respect to the VFA monomer).

### Testing as Biocides

### Materials and Bacterial Strains

Cellulose dialysis tubing device (Spectra/Por® 6 product No: 88-132582 8 kDa MWCO, Spectrum Laboratories, Inc and Spectra/Por® 6 product No: 132 594 3,500 MWCO) was purchased along with NaBr (Fluka), NaClO (Fluka), and 2,2,6,6-tetramethylpiperidine-1-oxyl radical (TEMPO) (Sigma-Aldrich).

As Hydrophobically modified polyvinylamine (PVAm) (M_{w} ca. 250,000) the polyvinylamine of example 3 above was used.

Poly(acrylic acid) (PAA) (M_{w} ca. 240,000) was purchased from Sigma-Aldrich. Escherichia coli; ATCC 11775, and Proteus mirabilis (P. mirabilis) were obtained from SIK (The Swedish Institute for Food and Biotechnology). Ringer's solution was prepared afresh as well as tryptone glucose extract (TGE). Growth agar medium used was Fluorocult E. coli O157:H7 agar, from MERCK. Phosphate buffers were prepared afresh. Ultra-pure water (Milli-Q plus system, Millipore) with a resistivity of 18.2 MΩ·cm was used in the experiments.

### Preparation of Coated Surfaces

### Step 1: Oxidation of Cellulose

Regenerated cellulose dialysis tubing was soaked in deionised water (40° C., 30 min.) in order to remove sodium azide. The cellulose dialysis tubing was then rinsed thoroughly with water and cut into pieces of size 5×5.4 cm (cellulose film with MWCO: 3,500). The pieces of cellulose tubing were cut open along one side and a centrefold was created. The films were once again rinsed in water. The oxidation process was performed according to the Kitaoka procedure [1] using TEMPO (2,2,6,6-tetramethyl-1-piperidnyloxy radical), NaBr and a ˜10% NaClO solution. Reactions took place in a beaker at 21° C. treating up to ˜9 grams of regenerated cellulose. The pH was maintained at 10.5 with 0.05M of NaOH and the oxidation was stopped by adding a small amount of ethanol to the solution and thereafter washed thoroughly in deionised water. The membranes were stored in ultra pure water at 4° C. ATR-FTIR analyses were used to confirm that an oxidation had taken place.

### Step 2: Polyelectrolyte and Solutions

PVAm (from example 3) was dialyzed using a dialysis membrane (Spectra/Por®6 product No: 88-132582 8000 Da MWCO, Spectrum Laboratories, Inc) for 5 days against water, changing the water several times a day. The product was dried in a vacuum freeze drier and stored in a desiccator at room temperature. The charge density at different values of pH of the polymer was determined using polyelectrolyte titration with potassium polyvinyl sulphate. PAA (M_{w} ca. 240,000, Sigma-Aldrich) was used without any further purification. PVAm and PAA solutions were prepared at 1 mg/ml in 10⁻² M NaCl, and in phosphate buffers at 10⁻³ M KH₂PO₄. The adsorption strategy was: pH 7.5 for the cationic solution and pH 3.5 for the anionic solution. The polyelectrolyte films were built on cellulose membranes in plastic Petri dishes at room temperature. The samples were dipped for 15 min alternatively in the polycationic and polyanionic solution. A rinsing solution of the same ionic strength and pH as the preceding polyelectrolyte solution was used after each adsorption step to remove excess polymer. 0.5, 2.5, and 5.5 bilayers (corresponding to 1, 5 and 11 monolayers) were built on the cellulose membranes with the outer layer being the positively charged polymer. The build-up and increase of PVAm was followed using nitrogen elemental analysis (ANTEK)

### Antibacterial Assessment

Escherichia coli (E. coli) were cultivated in 10 ml of TGE broth at 37° C. The bacterial cell concentration was quantified by decimal serial dilution with Ringer's solution. 100 μl samples from the dilution series was spread onto triplicate solid growth agar plates (Fluorocult). After incubation of the plates at 37° C., for 20 h, the number of colonies was counted manually. The concentration was estimated to ˜10⁹ E. coli CFU/ml after multiplying the result of the manual count with the dilution factor.

### Antibacterial Screening in Solution

Polymer suspension of PVAm (example 3) with the concentration of 250, 25, and 2.5 μg/ml were prepared and tested against a concentration of 10⁵ CFU/ml of E. coli. Polymers were suspended both in ultra pure water and in Ringer's solution. Bacteria were added to the solution of polymers to give the desired amount of bacterial cells in the sample. To investigate the inhibition of growth by PVAm (example 3) in solution 100 μL of each inoculated polymer suspension is applied on an agar plate (Fluorocult). A solution in ultra pure water/Ringer's solution without polymers is used as a reference. The plates were incubated at 37° C. for 20 h. The number of colonies on the agar plates was counted the following day.

FIG. 1 Antibacterial screening in solution: polymer evaluated both in
Ringer's solution and water against E. coli and P. mirabilis.

| | concentration | | CFU count: | CFU count: |
|---|---|---|---|---|
| | of polymer | polymer | control | polymer |
| bacterium | [μg/ml] | solvent | sample | sample |
| E. coli | 250 | Ringer's | 10⁴ | 0 |
| | | solution | | |
| | 25 | | 10⁴ | 58 |
| | 2.5 | | 10⁴ | ~10³ |
| E. coli | 250 | water | 10⁴ | 0 |
| | 25 | | 10⁴ | 0 |
| | 2.5 | | 10⁴ | 10⁴ |
| P. mirabilis | 250 | water | 10³ | 0 |
| | 25 | | 10³ | 0 |
| | 2.5 | | 10³ | 0 |

### Antibacterial Screening of Polyelectrolyte-Treated Cellulose Films

Untreated cellulose film (control) and cellulose films treated with polyelectrolyte were placed on solid growth agar and 5 μL of bacteria suspension (conc.: ˜10⁷ CFU/ml) was added onto the substrate. Since the cellulose film is based on a dialysis tubing device the membrane has a porous structure allowing the underlying agar growth medium to be in contact with the bacteria. The membranes have a fold on the middle as a result of the shape of the opened dialysis tubing device. Bacteria were placed on one side of the folded cellulose film (pristine or functionalized). The other side was folded on top of the incubated sample. This is done in order to evenly spread the bacteria over the test surface. The test samples were incubated for 20 h at 37° C. The number of colonies on the agar plates was studied the following day. The bacterial assays (both in solution and on cellulose films) were carried out in triplicate.

Only E. coli was used to investigate the antibacterial activity of the polymer-treated cellulose films. The activity against E. coli was studies as a function of adsorbed layers containing the modified PVAm (example 3). The inhibition of growth of E. coli of the functionalized cellulose film was investigated by a comparison of an untreated control sample. No quantification using the present method has been done as the colonies are difficult to count manually. It is, however, possible to distinguish the degree of growth by comparing the intensity of the yellow colour of the samples in relation to each other and control (untreated) samples. The sorbitol in the Fluorocult agar serves, together with pH indicator bromothymol blue, to determine the ability to degrade sorbitol. In the case of sorbitol-positive organisms (E. coli in the present study) the colonies of the bacteria turn yellow in colour. A decrease in the intensity of the yellow colour can be visualized as the number of layers containing modified PVAm is increased. The results indicate that E. coli are inhibited by the presence of PVAm and can not proliferate properly.

1. A biocidal multilayered system, comprising
an anionic or cationic carrier, and on the carrier alternating polymeric cationic and anionic layers starting with a layer having a charge opposite to the charge of the carrier, wherein at least one layer is hydrophobically modified.

2. The biocidal multilayered system according to claim 1, comprising an anionic carrier.

3. The biocidal multilayered system according to claim 2, wherein the anionic carrier is cellulose.

4. The biocidal multilayered system according to claim 1, wherein the cationic and anionic layers respectively comprise 0.1 to 22 milliequivalents of ionic groups/1 gram of polymer.

5. The biocidal multilayered system according to claim 1, wherein the amount of polymer applied per layer is 0.001 to 1000 mg of polymer/square meter.

6. The biocidal multilayered system according to claim 1, wherein the layered system comprises more than two polymeric layers.

7. The biocidal multilayered system according to claim 1, wherein all the cationic and anionic layers together have a film thickness in the range of 3 nm to 1 μm.

8. The biocidal multilayered system according to claim 1, wherein the polymer of the cationic layers is a polymer having ammonium groups.

9. The multilayered system according to claim 1, wherein the polymer of the anionic layers is a polyacid.

10. The biocidal multilayered system according to claim 1, wherein the anionic layers are bound to the cationic layers by formation of a polyelectrolyte complex of the anionic groups with the cationic groups.

11. The biocidal multilayered system according to claim 1, wherein one or more cationic layers are hydrophobically modified.

12. The biocidal multilayered system according to claim 1, wherein the final outer layer is a hydrophobically modified cationic layer.

13. The biocidal multilayered system according to claim 1, wherein the hydrophobically modified layer has a hydrophobic group in a content of 0.01 to 2.5 mol per 100 grams of polymer.

14. The biocidal multilayered system according to claim 13, wherein the hydrophobic groups comprise at least one of hydrocarbon groups, halogenated hydrocarbon groups, and alkoxy groups having at least three C atoms.

15. The biocidal multilayered system according to claim 13, wherein the hydrophobic group is bonded as a side group to the main polymer chain.

16. The biocidal multilayered system according to claim 13, wherein the hydrophobic layer comprises a hydrophobically modified polyvinylamine, wherein the hydrophobic group is bonded to the main chain by reaction with the primary amino group of the polyvinylamine by alkylating the amino group.

17. A method for producing a biocidal multilayered system, comprising alternately coating an anionic or cationic carrier with cationic and anionic layers respectively starting with a layer having a charge opposite to the charge of the carrier, wherein at least one layer is hydrophobically modified.

18-20. (canceled)

21. The biocidal multilayered system according to claim 1, wherein the polymer of the cationic layers is polyvinylamine.

22. The biocidal multilayered system according to claim 1, wherein the polymer of the anionic layers is polyacrylic acid or polymethacrylic acid.

23. The biocidal multilayered system according to claim 1, comprising an cationic carrier.
